(19) United States
(12) Patent Application Publication
(10) Pub. No.: US 2026/0109815 A1
(43) Pub. Date: Apr. 23, 2026

(54) LIQUID PHASE EXTRACTION OF TRITIATED AND RADIATION-GENERATED IMPURITIES FROM ORGANIC AND ORGANOSILICON OILS

(71) Applicant: BATTELLE SAVANNAH RIVER ALLIANCE, LLC, AIKEN, SC (US)

(72) Inventors: GEORGE K. LARSEN, AIKEN, SC (US); KORI D. MCDONALD, AUGUSTA, GA (US); JAMES A. FOLKERT, BEECH ISLAND, SC (US); TYLER C. GUIN, AIKEN, SC (US)

(21) Appl. No.: 18/918,221

(22) Filed: Oct. 17, 2024

(51) Int. Cl. C08G 65/46; C08G 77/34

(52) U.S. Cl. CPC C08G 65/46; C08G 77/34; C08G 2261/71

(57) ABSTRACT

A method for removing impurities from a damaged oil including an oil and impurities is provided. The method includes mixing the damaged oil with a solvent to form a mixture containing a solvent phase and a non-solvent phase and separating the solvent phase from the non-solvent phase. The solvent phase contains the solvent, recovered oil, and impurities in a first concentration. The non-solvent phase contains impurities in a second concentration. The second concentration is higher than the first concentration.

### STATEMENT REGARDING FEDERALLY SPONSORED RESEARCH OR DEVELOPMENT

This invention was made with government support under Contract No. 89303321CEM000080, awarded by the U.S. Department of Energy. The government has certain rights in the invention.

### BACKGROUND

Tritium is a low energy beta emitter, and while it is not dangerous externally, it is a radiation hazard upon inhalation, ingestion, or absorption. In much nuclear- and plasma-based research and work, gaseous tritium (T₂) is produced. Tritium can be produced in nuclear power generation as a by-product of the fission of uranium-235, plutonium-239, and uranium-233, as well as by neutron activation of lithium-6. In heavy water moderated and cooled reactors, tritium can be produced when a deuterium nucleus captures a neutron.

Tritium may be used to produce energy via the deuterium-tritium fusion reaction. In one proposed method for conducting such a reaction, an ultra-high vacuum needs to be generated within the torus of a tokamak reactor, where a plasma is generated. At extremely high temperatures, a fusion reaction may occur within the plasma fusing deuterium and tritium to form helium-5, which primarily decays into helium-4 and a free neutron, and in a rarer decay releases gamma radiation.

One proposed method for generating the ultra-high vacuum needed in the torus involves the use of diffusion pumps, which operate by using a heater to boil an oil with a low vapor pressure, directing the vapor through a jet assembly, and condensing it back to the heater. Common diffusion pump oils include organic and organosilicon oils. However, such oils are susceptible to degradation when exposed to tritium and/or radiation (e.g., gamma rays emitted from a fusion reaction). As such, oils are not traditionally used in radiation- and tritium-containing environments.

There is a need for a method for removing impurities in diffusion pump oils so they can be recycled and reused in diffusion pumps exposed to tritium and radiation and to simplify disposal of the degraded oils. Such a method would allow for more efficient use of diffusion vacuum pumps in fusion reaction systems.

### SUMMARY

Aspects and advantages of embodiments of the present disclosure will be set forth in part in the following description, or can be learned from the description, or can be learned through practice of the embodiments.

In one aspect, a method for removing impurities from a damaged oil including an oil and impurities is provided. The method includes mixing the damaged oil with a solvent to form a mixture containing a solvent phase and a non-solvent phase and separating the solvent phase from the non-solvent phase. The solvent phase contains the solvent, recovered oil, and impurities in a first concentration. The non-solvent phase contains impurities in a second concentration. The second concentration is higher than the first concentration.

In another aspect, a system for removing impurities from a damaged oil is provided. The system includes a damaged oil that has been exposed to radiation and/or tritium, a solvent, a liquid-liquid extractor, and an evaporator. The damaged oil includes an oil and impurities. The liquid-liquid extractor is configured to separate a solvent phase including a recovered oil and the solvent having a first concentration of impurities from a non-solvent phase including a second concentration of impurities. The second concentration is higher than the first concentration. The evaporator is configured to separate the solvent from the recovered oil.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 illustrates a flow chart of an example embodiment of a method for removing impurities from a damaged oil according to the present disclosure; and

FIG. 2 is a graph showing the results of the viscosity testing after each stage of extraction performed in Example 2.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

Organic and organosilicon oils are widely used as working fluids in industrial processes. However, oils have not traditionally been used in radiation and tritium containing environments due to the damaging effects of both and the incorporation of tritium into the labile portions of the molecules. For example, when these oils come in contact with tritium and/or radiation, impurities are generated. Specifically, when such oils are exposed to tritium (T₂), tritium exchange may occur where a tritium (T) isotope replaces a protium (H) isotope within the oil, producing a tritiated molecule. As the tritium decays, it may cause the formation of a free radical leading to crosslinking of the oil molecules, which can cause congealment of the oil and increased viscosity. Similarly, when the oils are exposed to radiation (e.g., beta, gamma, x-ray, and neutron), free radicals may also be formed, leading to crosslinking of the oil molecules.

It would be useful to be able to use such oils in tritium- and radiation-containing environments. For example, the use of such oils would be useful for defense programs, the fission industry, fusion industry, and the medical isotope industry. For example, it would be useful to be able to use diffusion vacuum pumps, which employ organic and organosilicon oils, to create the vacuum environments needed for fusion reactions, as described above.

As used herein, impurities in an oil may include tritiated and crosslinked molecules and a damaged oil refers to an oil containing impurities as a result of tritiation or radiation. In order to use organic and organosilicon oils in tritium- and radiation-containing environments, these impurities must be removed in order to recycle the oil or to prepare the oils for disposal.

Disclosed is a process that uses liquid solvents to selectively remove the impurities from the oil. By mixing the oils with the solvents, the oils are preferentially dissolved into the solvent, while the radiation damage and tritiated impurities remain in a separate phase. The solvent fraction is then separated from the undissolved fraction. The undissolved fraction may be further processed for disposal, while the solvent fraction may be further processed to recover the oil (e.g., by heating). The solvent may be further recovered via distillation. This recycling technique enables the use of these oils in tritium- and radiation-containing environments.

Previous approaches to detritiating oils include including vacuum degassing at room or elevated temperatures, air-blowing, vacuum distillation, catalyzed isotopic exchange, reaction with metallic sodium, direct oxidation of the entire oil, and adsorption on solid sorbents. However, the liquid phase approach described herein is advantageous in that both tritiated and radiation damage impurities are removed in a single step, and the solvent can be reused, reducing costs and simplifying disposal. As such, the method described herein reduces disposal costs by significantly lowering the volumes of components wasted and by recovering valuable tritium for reuse.

Advantageously, the liquid-liquid extraction method described herein can be performed using simple equipment. For example, it can be employed without the use of solid phase extraction cartridges, catalysts, solids, etc.

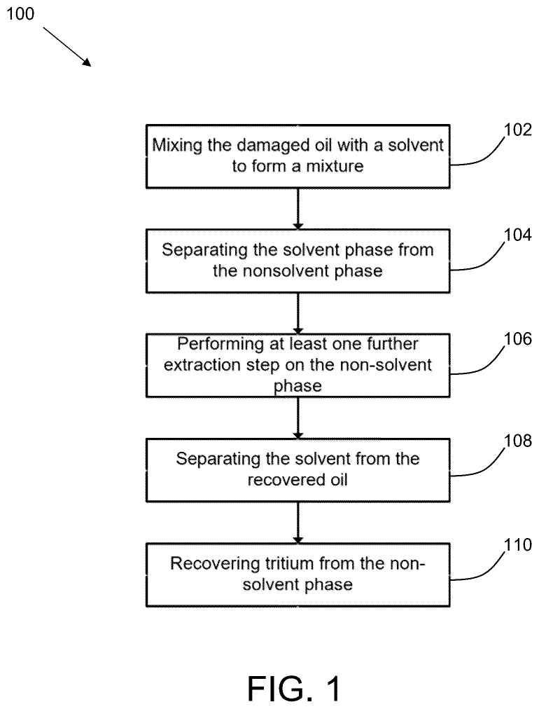

FIG. 1 depicts a flow chart diagram of an example method 100 according to example embodiments of the present disclosure. FIG. 1 depicts example method steps for purposes of illustration and discussion. Those of ordinary skill in the art, using the disclosures provided herein, will understand that the methods described in the present disclosure may be adapted, modified, include steps not illustrated, omitted, and/or rearranged without deviating from the scope of the present disclosure.

In general method 100 is a method for removing impurities from a damaged oil including an oil and impurities. At (102), method 100 may include mixing the damaged oil with a solvent to form a mixture.

As used herein, an oil may include any organic fluid that may be used in industrial equipment, such as an oil diffusion pump. Organic and organosilicon oils according to disclosed methods and systems can include, without limitation, pump oils, sealants, coatings, greases, solvents, polymers, pharmaceuticals, thermal transfer fluids, catalysts, organometallics, hydrocarbons, ethers, urethanes, polyols, silicones, silanols, siloxides, siloxanes, silyl ethers, silyl hydrides, etc., as well as combinations of materials.

Specific examples of oils that may be use according to the methods and systems described herein and/or may be used as additives to such oils can include, without limitation: aliphatic hydrocarbon oils, such as mineral oils, including purified mineral oil; organosilicon oils, such as tetramethyl tetraphenyl trisiloxane and pentaphenyl trimethyl trisiloxane; and polyphenyl ethers, such as alkyl diphenyl ether, pentaphenyl ether (5-ring polyphenyl ether), tetraphenyl ether (4-ring polyphenyl ether), monoalkyl tetraphenyl ether, dialkyl tetraphenyl ether, alkyl diphenyl ether; as well as combinations thereof.

In some embodiments, an oil to be recycled according to the methods described herein can include an organic compound that has been selected for desirable properties in a tritium-containing process. For instance, an oil (e.g., a lubricating oil or diffusion pump oil) can include an organic compound that exhibits resistance to radiation-induced modification. Such compounds may include saturated hydrocarbons (e.g., paraffins, heptane) and unsaturated hydrocarbons (e.g., heptane-3, monocyclic aromatics, olefins, cyclohexene, maphalene, methylnaphpthalene, indene, D10 aromatics, C9 aromatics, tetralin, and tetramethylbenzene). The materials can be utilized as oils in a process or may be included as an additive with one or more other components (e.g., a more traditional oil for the process) or may be included as the primary component of the oil. In such a case, the material may exhibit useful properties for their intended application. For example, a compound for use as a vacuum oil, in addition to the above properties, should also exhibit a low vapor pressure.

The solvent may be any solvent which leads to the formation of two distinct phases when mixed with the damaged oil and which dissolves and/or is miscible with the oil, while leaving the majority of the impurities in the non-solvent phase. In some embodiments, the solvent phase is the top phase and the non-solvent phase is the bottom phase. However, in other embodiments, the solvent phase can be the bottom phase and the non-solvent phase can be the top phase. In some embodiments, the mixture may also form a third phase, such as a precipitate. Such mixtures may also be suitable in the method described herein.

In some embodiments, the solvent may include an aqueous solvent. For example, the solvent may include an aqueous base, such as aqueous sodium hydroxide, aqueous ammonium hydroxide, or aqueous sodium bicarbonate. In other embodiments, the solvent may include an aqueous acid, such as aqueous hydrochloric acid.

In aqueous solvents, the acid or base may have a concentration from about 0.1 M or more, such as about 0.5 M or more, such as about 0.8 M or more, such as about 1 M or more, such as about 2 M or more, such as about 5 M or more, such as about 8 M or more, such as about 10 M or more, such as about 12 M or more, such as about 14M or more. The concentration may be about 20 M or less, such as about 16 M or less, such as about 14 M or less, such as about 12 M or less, such as about 10 M or less, such as about 8 M or less, such as about 5 M or less, such as about 2 M or less, such as about 1.5 M or less, such as about 1 M or less, such as about 0.7 M or less, such as about 0.5 M or less.

In some embodiments, the solvent may include a pure acid, such as phosphoric acid or acetic acid. In other embodiments, the solvent may include a pure base, such as pyridine.

As used herein, a pure acid or base may have a purity of about 90 wt. % or more, such as about 95 wt. % or more, such as about 98 wt. % or more, such as about 99 wt. % or more, such as about 100 wt. %.

In some embodiments, the solvent may include an organic solvent, such as a polar organic solvent or a nonpolar organic solvent.

In some embodiments, the polar organic solvent may include an alcohol, such as a mono-alcohol or polyol. For example, the alcohol may include methanol, isopropanol, octanol, or ethylene glycol. In other embodiments, the polar organic solvent may include a polar aprotic solvent, such as acetone, acetonitrile, ethyl acetate, dimethylsulfoxide (DMSO), dimethylformamide (DMF), or N-methyl-2-pyrrolidone (NMP).

In some embodiments, the nonpolar organic solvent may include hexane or a chlorinated nonpolar solvent, such as dichloromethane.

In some embodiments, the solvent may have a boiling point of about 50° C. or greater, such as about 60° C. or greater, such as about 75° C. or greater, such as about 100° C. or greater, such as 120° C. or greater, such as about 150° C. or greater, such as about 175° C. or greater. Preferably, the boiling point of the solvent is sufficiently different from the boiling point of the oil such that the two can be easily separated by evaporation of one from the other.

In some embodiments, the solvent may be chosen based on the type of oil to be extracted. For example, it was found that some solvents are particularly useful for recovering certain types of oils.

In some embodiments, for example, the oil includes a hydrocarbon oil (e.g., mineral oil) and the solvent includes an acid, base, alcohol, polar aprotic solvent, or a nonpolar chlorinated solvent. For example, in some embodiments the oil includes mineral oil and the solvent includes aqueous hydrochloric acid, aqueous sodium hydroxide, aqueous ammonium hydroxide, aqueous sodium bicarbonate, pure acetic acid, pure phosphoric acid, pyridine, methanol, isopropanol, ethylene glycol, acetone, acetonitrile, ethyl acetate, DMSO, DMF, NMP, or dichloromethane.

In other embodiments, the oil includes a polyphenyl ether and the solvent includes an acid, a base, an alcohol, or a linear hydrocarbon. For example, in some embodiments, the oil includes tetraphenyl ether or pentaphenyl ether and the solvent includes aqueous hydrochloric acid, aqueous sodium hydroxide, aqueous ammonium hydroxide, aqueous sodium bicarbonate, pure phosphoric acid, methanol, isopropanol, octanol, ethylene glycol, or hexane. In some embodiments, the oil includes a polyphenyl ether (e.g., tetraphenyl ether) and the solvent includes a linear hydrocarbon (e.g., n-hexane).

In other embodiments, the oil includes an organosiloxane and the solvent includes an acid, base, or alcohol. For example, in some embodiments, the oil includes pentaphenyl trimethyl trisiloxane or tetraphenyl tetramethyl trisiloxane and the solvent includes aqueous hydrochloric acid, aqueous sodium hydroxide, aqueous ammonium hydroxide, aqueous sodium bicarbonate, pure phosphoric acid, methanol, isopropanol, octanol, or ethylene glycol. In some embodiments, the oil includes pentaphenyl trimethyl trisiloxane or tetraphenyl tetramethyl trisiloxane and the solvent includes an alcohol (e.g., isopropanol, methanol, or octanol).

The ratio of solvent to damaged oil in the mixture is not particularly limited. Enough solvent should be used to cause the desired phase separation. While there is not necessarily an upper limit to the amount of solvent used, the amount of energy needed to separate (e.g., evaporate) the solvent from the recovered oil should be considered. In this regard, in some embodiments, the volume ratio of solvent to damaged oil in the mixture may be about 0.1 or more, such as about 0.3 or more, such as about 0.5 or more, such as about 0.8 or more, such as about 1 or more, such as about 2 or more, such as about 3 or more, such as about 4 or more. The ratio may be about 10 or less, such as about 8 or less, such as about 5 or less, such as about 3 or less, such as about 2 or less, such as about 1 or less, such as about 0.7 or less, such as about 0.5 or less.

When multiple extraction steps (i.e., stages) are used, the above volume ratios may also apply to each successive step, where the damaged oil is the non-solvent phase separated from the previous step.

The mixture may be formed by any suitable method. For example, in some embodiments, the oil and solvent are placed in a vessel together and mixed (e.g., stirred or agitated) to form an emulsion. The emulsion is then left to settle, and a phase separation occurs.

Upon settling, a solvent phase and a non-solvent phase emerge. The solvent phase includes the solvent and the recovered oil. The non-solvent phase includes the impurities. A small amount of the impurities may end up in the solvent phase due to imperfect separation. For example, the concentration of impurities in the solvent phase may be about 2 wt. % or less, such as about 1 wt. % or less, such as about 0.5 wt. % or less, such as about 0.2 wt. % or less, such as about 0.1 wt. % or less, such as about 500 ppm or less, such as about 100 ppm or less. In some embodiments, the solvent phase is free of impurities (i.e., the concentration is 0 wt. %).

A small amount of oil may be present in the non-solvent phase due to imperfect separation. Preferably, however, a majority of the oil in the damaged oil is present in the solvent phase. For example, the volume ratio of oil in the solvent phase to oil in the non-solvent phase may be about 1 or more, such as about 1.2 or more, such as about 1.5 or more, such as about 1.7 or more, such as about 2 or more, such as about 2.2 or more, such as about 2.5 or more, such as about 2.7 or more, such as about 3 or more. The volume ratio may be about 20 or less, such as about 15 or less, such as about 10 or less, such as about 8 or less, such as about 5 or less, such as about 4 or less, such as about 3 or less.

When multiple extraction steps are performed, the concentration of impurities in each solvent phase may be slightly greater than in the previous stage. However, more oil is recovered from the non-solvent phase during each successive extraction step.

The extraction process may be performed at ambient temperatures and pressures. The process may be performed in batch phase (e.g., using a separating funnel) or may be performed continuously. Suitable continuous liquid-liquid extraction techniques include, for example, multistage countercurrent, cross-current, or co-current continuous processes (e.g., using mixer-settlers or centrifugal extractors). While the method described herein mostly focuses on batch liquid-liquid extraction techniques, it should be understood that the method may include any method of recovering oil from a damaged oil using liquid-liquid extraction performed by any suitable means. For example, on an industrial scale, it may be useful to use a continuous extraction process.

At (104), method 100 may include separating the solvent phase from the nonsolvent phase. Separation may be performed by any suitable means, many of which are well known in the field of liquid-liquid extraction. For example, as mentioned above, the mixture may be placed or formed in a separatory funnel in which the bottom phase settles to the bottom and the top phase settles to the top. As explained above, in some embodiments, the solvent phase is the top phase and the non-solvent phase is the bottom phase. However, in other embodiments, the solvent phase may be the bottom phase and the non-solvent phase may be the top phase.

The bottom phase can be drained from the separatory funnel through a valve, leaving the top phase in the funnel. Such a process can be performed manually or can be automated. In some embodiments, the separation may be performed as part of a continuous liquid-liquid extraction process, such as in a mixer-settler or a centrifugal extractor.

At (106), method 100 may include performing at least one further extraction step on the non-solvent phase. In some embodiments, the further extraction step includes mixing the non-solvent phase resulting from the previous extraction step with more solvent to form another mixture including a further solvent phase and a further non-solvent phase. The solvent used for this step may be new solvent or solvent recovered from a previous extraction step. In the case of a countercurrent liquid-liquid extraction process, the solvent used in a further extraction step may be the extract (i.e., solvent phase) separated from another extraction step or unit.

The further extraction step(s) are performed similarly to the first extraction step described above in steps (102) and (104). For example, the solvent may be mixed with the non-solvent phase of a previous extraction step to form an unstable emulsion, the emulsion settles to form a solvent phase and a non-solvent phase, and the solvent phase is separated from the non-solvent phase. The volume ratio of further solvent used to the volume of the non-solvent phase from the previous extraction step may be the same as described above for the first step (e.g., from 0.1 to 10, such as about 0.5).

As in the first extraction step, the resulting solvent phase contains recovered oil and the solvent, and the non-solvent phase contains impurities. The solvent phase may contain a small concentration of impurities, but the concentration of impurities in the non-solvent phase is higher than in the solvent phase. With each successive extraction step, more oil may be recovered from the non-solvent phase but the concentration of impurities in the recovered oil may increase. The number of further extraction steps can be determined based on the separation efficiency of the system, the desired oil recovery, and the desired purity of the recovered oil. In some embodiments, the total number of extraction steps, including the first extraction step described in steps (102) and (104) of method 100, is from 1 to 10, such as from 2 to 8, such as from 3 to 6, such as from 4 to 5.

At (108), method 100 may include separating the solvent from the recovered oil. The separation may be performed by any suitable process. In some embodiments, for example, the solvent may be evaporated from the solvent phase (i.e., evaporated from the recovered oil). Evaporation may occur in an evaporator or in a distillation apparatus. Evaporation may be performed under vacuum. While it is likely that the solvent has a much lower boiling point than the oil, it should be understood that if the solvent has a higher boiling point than the oil, the oil can be evaporated from the solvent.

Upon evaporation, the solvent can be condensed, recovered, and optionally purified (e.g., by distillation) for further use in further extraction steps or elsewhere. The recovered oil can have a high purity and can be reused. For example, if the oil is from an oil diffusion vacuum pump, it can be recycled back to the pump for further use. Optionally, the oil can be further processed and purified further, if desired.

When the process contains multiple extraction steps, the solvent phases from each of the extraction steps may be combined together for separation of the solvent from the recovered oil. Alternatively, the solvent in each of the resulting solvent phases may be removed from the recovered oil separately. If the solvent in each recovered solvent phase is separately removed (e.g., evaporated), the resulting amounts of recovered oil can be combined afterward and recycled. In embodiments using a countercurrent extraction process, the resulting solvent phase (i.e., stream) is the product of multiple extraction steps and can be collected and separated in a batch process or can be separated and recycled continuously by any suitable means (e.g., a continuous distillation or evaporation process).

At (110), method 100 may include recovering tritium from the non-solvent phase. Tritium may be recovered by any suitable process, such as by isotope exchange and tritium recovery. Such processes are described, for example, in U.S. Pat. No. 11,981,613, which is incorporated herein by reference.

Tritium that is separated and recovered can be suitable for any use as is known in the art. For instance, the recovered tritium can be recycled to a tritium-containing process that utilizes tritium, such as a fusion process. In other embodiments, the separated tritium can be collected and utilized in self-powered lighting applications as a replacement for radium, as a fuel for controlled nuclear fusion reactions, or can be provided to a catalytic exchange system as described above and utilized as a chemical tracer, for instance as a radiolabel of an organic or organosilicon material or as a tracer in ocean circulation and ventilation.

In some embodiments, the resulting non-solvent phase may be further processed as waste.

The disclosed process may be used to recover damaged oil at a relatively high efficiency. For example, the extraction efficiency (amount of oil recovered/amount of damaged oil entering the extraction process) may be about 50% or greater, such as about 60% or greater, such as about 65% or greater, such as about 70% or greater, such as about 75% or greater.

Further, the recovered oil may be essentially free of impurities. For example, in some embodiments, the concentration of impurities in the recovered oil is about 2 wt. % or less, such as about 1 wt. % or less, such as about 0.5 wt. % or less, such as about 0.2 wt. % or less, such as about 0.1 wt. % or less, such as about 500 ppm or less, such as about 100 ppm or less. In some embodiments, the solvent phase is free of impurities (i.e., the concentration is 0 wt. %).

The recovered oil may have a viscosity similar to the viscosity of pure oil. For example, a ratio of the viscosity of the recovered oil to the viscosity of the pure oil may be about 2 or less, such as about 1.7 or less, such as about 1.5 or less, such as about 1.3 or less, such as about 1.2 or less, such as about 1.1 or less. As used herein, pure oil refers to the oil prior to tritiation and/or radiation damage. The change in viscosity in the oil may be used as an indicator of the effectiveness of the extraction process. As such, the suitability of a solvent for recovering a specific type of damaged oil may be characterized by performing a series of extraction steps and measuring the difference in viscosity between the recovered oil and the pure oil relative to the difference in viscosity between the damaged oil and the pure oil.

To test the suitability of a given system containing an oil and a solvent, the viscosity of the pure oil may be measured. Then the oil is irradiated with a given level of gamma radiation (e.g., 4.5 MGy or 7 MGy) to produce a damaged oil. The viscosity of the damaged oil is measured. Then, a series of batch liquid-liquid extraction steps may be performed using a volume ratio of solvent to damaged oil of 0.5 (i.e., for 10 ml of damaged oil, 5 ml of solvent is used). The liquid-liquid extraction steps may be performed by mixing the solvent with the damaged oil in a beaker, agitating/stirring the mixture to form an emulsion, placing the emulsion into a separatory funnel, and letting the emulsion settle. Then, the bottom phase is removed from the top phase through a valve. The solvent phase (whether top or bottom) is collected. The non-solvent phase is then used as the “damaged oil” to be used in the next extraction step, which is performed in the same manner. After four extraction steps generating four collected solvent phases, the four collected solvent phases are combined, and the solvent is evaporated from the recovered oil under vacuum. The viscosity of the recovered oil is then measured. Viscosity may be measured according to ASTM D 445 at 25° C.

In some embodiments, when tested according to the method described above, the ratio of (viscosity of combined recovered oil—viscosity of pure oil)/(viscosity of damaged oil—viscosity of pure oil) is less than 1, such as less than 0.7, such as less than 0.5, such as less than 0.4, such as less than 0.2, such as less than 0.15, such as less than 0.1, such as less than 0.05.

Also disclosed is a system for performing the described method. The system generally includes a damaged oil that has been exposed to radiation and/or tritium, a solvent, a liquid-liquid extractor, and an evaporator. The damaged oil includes an oil and impurities as described above. For example, the oil can be any of those used in step (102) of method 100 (e.g., mineral oil, a polyphenyl ether, or an organosilicon oil). The solvent may similarly be any of those described above with respect to step (102) of method 100.

As described, the solvent may be selected based on its suitability for liquid-liquid extraction of the specific oil used. For example, in some embodiments the oil includes mineral oil and the solvent includes aqueous hydrochloric acid, aqueous sodium hydroxide, aqueous ammonium hydroxide, aqueous sodium bicarbonate, pure acetic acid, pure phosphoric acid, pyridine, methanol, isopropanol, ethylene glycol, acetone, acetonitrile, ethyl acetate, DMSO, DMF, NMP, or dichloromethane. In some embodiments, the oil includes a polyphenyl ether (e.g., tetraphenyl ether) and the solvent includes a linear hydrocarbon (e.g., n-hexane). In some embodiments, the oil includes pentaphenyl trimethyl trisiloxane or tetraphenyl tetramethyl trisiloxane and the solvent includes an alcohol (e.g., isopropanol, methanol, or octanol).

The liquid-liquid extractor may be any suitable system for performing liquid-liquid extraction. For example, the liquid-liquid extractor may be any system configured to separate a solvent phase containing the recovered oil and the solvent from a non-solvent phase containing impurities in a higher concentration than in the solvent phase. For example, as described above, the extractor may be as simple as a separatory funnel or series thereof for a batch process, or it may be a series of mixer-settlers or centrifugal extractors used in a cross-current or countercurrent extraction process which may or may not be continuous.

The evaporator may be any suitable apparatus for separating the solvent from the recovered oil. For example, the evaporator may be a heated vessel with a condenser or may be a distillation column/apparatus. The evaporator may be configured to operate under vacuum.

Disclosed methods and systems can be utilized in many different industries including, without limitation, fusion, defense, pharmaceutical, biomedical, LED, semiconductor, optical fiber, polymer, etc.

The present disclosure may be better understood with reference to the Examples set forth below.

In the examples described below, viscosity was measured according to ASTM D 445 at 25° C.

### Example 1

A liquid-liquid extraction process was used to recover Santovac 9 (a polyphenyl ether vacuum diffusion pump oil) that had been damaged by gamma radiation.

The viscosity of pure Santovac 9 was measured. One oil sample was then exposed to 4.5 MGy of gamma radiation and another sample was exposed to 7 MGy of gamma radiation to form damaged oil samples. The viscosities of the damaged oil samples were also measured.

Hexane was used as a solvent for liquid-liquid extraction. In each extraction step, the ratio of solvent used to damaged oil (equivalent to the non-solvent phase in subsequent extraction steps) was 4. In each extraction step, the solvent was mixed with the damaged oil in a beaker to form a mixture, the mixture was agitated to form an emulsion, the emulsion was placed into a separatory funnel and left to settle. Then, the bottom phase (non-solvent phase) was removed from the top phase (solvent phase) through a valve. The solvent phase was collected. The non-solvent phase was then used as the “damaged oil” to be used in the next extraction steps, which were performed in the same manner. After four extraction steps generating four collected solvent phases, the four collected solvent phases were combined, and the solvent was evaporated from the recovered oil at 80° C. under high vacuum. The viscosity of the recovered oil was then measured. The results are shown in Table 1 below. The extraction efficiency for the 4.5 MGy irradiated sample was 77.3% and the extraction efficiency for the 7 MGy irradiated oil was 73.1%.

TABLE 1

| Sample | Visc. (cP) 25° C. | % Change |
|---|---|---|
| Pure Santovac 9 | 221.3 | — |
| Damaged Oil after 4.5 MGy γ | 316.5 | +43% |
| Recovered Oil (4 extraction steps) | 262.9 | +19% |
| Remaining Non-solvent phase | 724.3 | +227% |
| Damaged Oil after 7 MGy γ | 352.2 | +59% |
| Recovered Oil (4 extraction steps) | 267.9 | +21% |
| Remaining Non-solvent phase | 1052 | +375% |

### Example 2

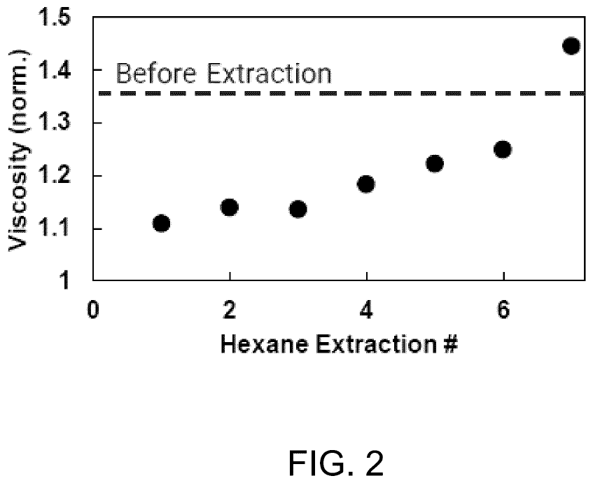

The same liquid-liquid extraction process was performed as in Example 1 except that the volume ratio of hexane to damaged oil was 0.5. The damaged oil was prepared by exposure of the Santovac 9 oil to 4.5 MGy of gamma radiation. A graph showing the normalized viscosity of the oil recovered after each extraction is shown in FIG. 2.

### Example 3

Various combinations of solvents and oils were tested for their compatibility for liquid-liquid extraction. Mixtures resulting in at least two phases may be suitable for the process. The results are shown in Tables 2-4 below. Table 2 shows the results when the oil is LVO 500, a mineral oil diffusion pump oil. Table 3 show the results when the oil is Santovac 9, and Table 4 shows the results when the oil is CQ705, an organosiloxane vacuum diffusion pump oil.

TABLE 2
(LVO 500)

| Solvent | Solvent Type | Phases |
|---|---|---|
| 1M HCl | Aqueous strong acid | 2 |
| 1M NaOH | Aqueous strong base | 2 |
| Conc. NH₄OH | Aqueous base | 2 |
| Phosphoric acid 98% | Pure acid | 2 |
| NaHCO₃ | Aqueous mild base | 2 |
| Methanol | Polar mono-alcohol | 2 |
| Isopropanol | Polar mono-alcohol | 2 |
| Octanol | Polar mono-alcohol | 1 |
| Ethylene Glycol | Polar di-alcohol | 2 |
| Acetone | Polar aprotic | 2 |
| Acetonitrile | Polar aprotic | 2 |
| THF | Polar aprotic | 1 |
| Acetic Acid | Pure weak acid | 2 |
| Ethyl Acetate | Polar aprotic | 2 |
| Octanoic Acid | Pure weak acid | 1 |
| Benzene | Nonpolar | 1 |
| Chlorobenzene | Nonpolar | 1 |
| Benzotrifluoride | Nonpolar | 1 |
| Phenol | Mildly acidic | 1 |
| Toluene | Nonpolar | 1 |
| Pyridine | Mildly basic | 2 |
| Hexane | Nonpolar | 1 |
| Cyclohexane | Nonpolar | 1 |
| Tetrachloroethylene | Nonpolar chlorinated | 1 |
| Dichloromethane | Nonpolar chlorinated | 2 |
| Chloroform | Nonpolar chlorinated | 1 |
| DMSO | Polar aprotic | 2 |
| DMF | Polar aprotic | 2 |
| NMP | Polar aprotic | 2 |

TABLE 3
(Santovac 9)

| Solvent | Solvent Type | Phases |
|---|---|---|
| 1M HCl | Aqueous strong acid | 2 |
| 1M NaOH | Aqueous strong base | 2 |
| Conc. NH₄OH | Aqueous base | 2 |
| Phosphoric acid 98% | Pure acid | 2 |
| NaHCO₃ | Aqueous mild base | 2 |
| Methanol | Polar mono-alcohol | 3 |
| Isopropanol | Polar mono-alcohol | 3 |
| Octanol | Polar mono-alcohol | 2 |
| Ethylene Glycol | Polar di-alcohol | 2 |
| Acetone | Polar aprotic | 1 |
| Acetonitrile | Polar aprotic | 1 |
| THF | Polar aprotic | 1 |
| Acetic Acid | Pure weak acid | 1 |
| Ethyl Acetate | Polar aprotic | 1 |
| Octanoic Acid | Pure weak acid | 1 |
| Benzene | Nonpolar | 1 |
| Chlorobenzene | Nonpolar | 1 |
| Benzotrifluoride | Nonpolar | 1 |
| Phenol | Mildly acidic | 1 |
| Toluene | Nonpolar | 1 |
| Pyridine | Mildly basic | 1 |
| Hexane | Nonpolar | 2 |
| Cyclohexane | Nonpolar | 1 |
| Tetrachloroethylene | Nonpolar chlorinated | 1 |
| Dichloromethane | Nonpolar chlorinated | 1 |
| Chloroform | Nonpolar chlorinated | 1 |
| DMSO | Polar aprotic | 1 |
| DMF | Polar aprotic | 1 |
| NMP | Polar aprotic | 1 |

TABLE 4
(CQ705)

| Solvent | Solvent Type | Phases |
|---|---|---|
| 1M HCl | Aqueous strong acid | 2 |
| 1M NaOH | Aqueous strong base | 2 |
| Conc. NH₄OH | Aqueous base | 2 |
| Phosphoric acid 98% | Pure acid | 2 |
| NaHCO₃ | Aqueous mild base | 2 |
| Methanol | Polar mono-alcohol | 2 |
| Isopropanol | Polar mono-alcohol | 2 |
| Octanol | Polar mono-alcohol | 2 |
| Ethylene Glycol | Polar di-alcohol | 2 |
| Acetone | Polar aprotic | 1 |
| Acetonitrile | Polar aprotic | 1 |
| THF | Polar aprotic | 1 |
| Acetic Acid | Pure weak acid | 1 |
| Ethyl Acetate | Polar aprotic | 1 |
| Octanoic Acid | Pure weak acid | 1 |
| Benzene | Nonpolar | 1 |
| Chlorobenzene | Nonpolar | 1 |
| Benzotrifluoride | Nonpolar | 1 |
| Phenol | Mildly acidic | 1 |
| Toluene | Nonpolar | 1 |
| Pyridine | Mildly basic | 1 |
| Hexane | Nonpolar | 1 |
| Cyclohexane | Nonpolar | 1 |
| Tetrachloroethylene | Nonpolar chlorinated | 1 |
| Dichloromethane | Nonpolar chlorinated | 1 |
| Chloroform | Nonpolar chlorinated | 1 |
| DMSO | Polar aprotic | 1 |
| DMF | Polar aprotic | 1 |
| NMP | Polar aprotic | 1 |

### Example 4

A liquid-liquid extraction process was used to recover 00705 (an organosiloxane vacuum diffusion pump oil) that had been damaged by gamma radiation.

The viscosity of pure 00705 was measured. Three oil samples were then exposed to 7 MGy of gamma radiation to form damaged oil samples. The viscosity of a damaged oil sample was also measured.

Isopropanol, methanol, and octanol were used as solvents for liquid-liquid extraction. In each extraction step, the ratio of solvent used to damaged oil (equivalent to the non-solvent phase in subsequent extraction steps) was 0.5. In each extraction step, the solvent was mixed with the damaged oil in a beaker to form a mixture, the mixture was agitated to form an emulsion, the emulsion was placed into a separatory funnel and left to settle. Then, the bottom phase (non-solvent phase) was removed from the top phase (solvent phase) through a valve. The solvent phase was collected. The non-solvent phase was then used as the “damaged oil” to be used in the next extraction steps, which were performed in the same manner. After each extraction step, the solvent was evaporated from the recovered oil. The viscosity of the recovered oil was then measured. The results are shown in Table 5 below.

TABLE 5

| Sample | Visc. [cP] |
|---|---|
| Pure CQ705 (control) | 183.6 |
| Damaged oil after 7 MGy γ | 298.7 |
| Isopropanol 1st extraction stage | 182.6 |
| Isopropanol 2nd extraction stage | 197.4 |
| Isopropanol 3rd extraction stage | 211.3 |
| Isopropanol 4th extraction stage | 254.0 |
| Non-solvent phase after 4 IPA extraction stages | 13320 |
| Methanol 1st extraction stage | 160.7 |
| Methanol 2nd extraction stage | 182.6 |
| Methanol 3rd extraction stage | 174.6 |
| Methanol 4th extraction stage | 201.4 |
| Non-solvent phase after 4 methanol extraction stages | 1761 |
| Octanol 1st extraction stage | 285.8 |
| Octanol 2nd extraction stage | 269.9 |

While certain embodiments of the disclosed subject matter have been described using specific terms, such description is for illustrative purposes only, and it is to be understood that changes and variations may be made without departing from the spirit or scope of the subject matter.

What is claimed is:

1. A method for removing impurities from a damaged oil comprising an oil and impurities, the method comprising:
mixing the damaged oil with a solvent to form a mixture, the mixture containing;
a solvent phase containing the solvent, recovered oil, and impurities in a first concentration; and
a non-solvent phase containing impurities in a second concentration, the second concentration being higher than the first concentration; and
separating the solvent phase from the non-solvent phase.

2. The method of claim 1, further comprising separating the solvent from the recovered oil in the solvent phase.

3. The method of claim 1, wherein the oil comprises mineral oil.

4. The method of claim 3, wherein the solvent comprises aqueous hydrochloric acid, aqueous sodium hydroxide, aqueous ammonium hydroxide, aqueous sodium bicarbonate, pure acetic acid, pure phosphoric acid, pyridine, methanol, isopropanol, ethylene glycol, acetone, acetonitrile, ethyl acetate, DMSO, DMF, NMP, or dichloromethane.

5. The method of claim 1, wherein the oil comprises polyphenyl ether.

6. The method of claim 5, wherein the solvent comprises aqueous hydrochloric acid, aqueous sodium hydroxide, aqueous ammonium hydroxide, aqueous sodium bicarbonate, pure phosphoric acid, methanol, isopropanol, octanol, ethylene glycol, or hexane.

7. The method of claim 1, wherein the oil comprises an organosilicon.

8. The method of claim 7, wherein the solvent comprises aqueous hydrochloric acid, aqueous sodium hydroxide, aqueous ammonium hydroxide, aqueous sodium bicarbonate, pure phosphoric acid, methanol, isopropanol, octanol, or ethylene glycol.

9. The method of claim 1, further comprising performing at least one further extraction step on the non-solvent phase, wherein each extraction step comprises mixing the non-solvent phase with the solvent to form a mixture comprising a further solvent phase containing recovered oil and the solvent; and a further non-solvent phase containing impurities in a higher concentration than in the further solvent phase.

10. The method of claim 9, wherein the process comprises from 3 to 6 extraction steps.

11. The method of claim 1, wherein the solvent is selected such that the following equation is true:
$$\frac{viscosity of combined recovered oil - viscosity of pure oil}{viscosity of damaged oil - viscosity of pure oil} < 0.5$$
wherein the viscosity of combined recovered oil is measured according to ASTM D 445 at 25° C. after combining the solvent phases resulting from four extraction stages and evaporating the solvent from the recovered oil,
wherein each extraction stage comprises mixing the damaged oil with an amount of the solvent equal to half the volume of the damaged oil to form a mixture comprising a solvent phase and a non-solvent phase, separating the non-solvent phase from the solvent phase, and using the non-solvent phase as the damaged oil for the next stage,
and wherein the initial damaged oil is formed by subjecting the pure oil to 4.5 MGy of gamma radiation.

12. The method of claim 1, wherein the first concentration is less than 1 wt. %.

13. The method of claim 1, wherein the recovered oil in the solvent phase constitutes about 50 wt. % or more of the oil in the damaged oil.

14. The method of claim 1, wherein the solvent has a boiling point of about 50° C. or greater.

15. A system for removing impurities from a damaged oil, the system comprising:
a damaged oil that has been exposed to radiation and/or tritium, the damaged oil comprising an oil and impurities;
a solvent;
a liquid-liquid extractor configured to separate a solvent phase comprising a recovered oil and the solvent having a first concentration of impurities from a non-solvent phase comprising a second concentration of impurities, the second concentration being higher than the first concentration; and
an evaporator configured to separate the solvent from the recovered oil.

16. The system of claim 15, wherein the oil comprises mineral oil and the solvent comprises aqueous hydrochloric acid, aqueous sodium hydroxide, aqueous ammonium hydroxide, aqueous sodium bicarbonate, pure acetic acid, pure phosphoric acid, pyridine, methanol, isopropanol, ethylene glycol, acetone, acetonitrile, ethyl acetate, DMSO, DMF, NMP, or dichloromethane.

17. The system of claim 15, wherein the oil comprises polyphenyl ether and the solvent comprises aqueous hydrochloric acid, aqueous sodium hydroxide, aqueous ammonium hydroxide, aqueous sodium bicarbonate, pure phosphoric acid, methanol, isopropanol, octanol, ethylene glycol, or hexane.

18. The system of claim 15, wherein the oil comprises an organosilicon oil and the solvent comprises aqueous hydrochloric acid, aqueous sodium hydroxide, aqueous ammonium hydroxide, aqueous sodium bicarbonate, pure phosphoric acid, methanol, isopropanol, octanol, or ethylene glycol.

19. The system of claim 15, wherein the solvent is selected such that the following equation is true:
$$\frac{viscosity of combined recovered oil - viscosity of pure oil}{viscosity of damaged oil - viscosity of pure oil} < 0.5$$
wherein the viscosity of combined recovered oil is measure according to ASTM D 445 at 25° C. after combining the solvent phases resulting from four extraction stages and evaporating the solvent from the recovered oil,
wherein each extraction stage comprises mixing the damaged oil with an amount of the solvent equal to half the volume of the damaged oil to form a mixture comprising a solvent phase and a non-solvent phase, separating the non-solvent phase from the solvent phase, and using the non-solvent phase as the damaged oil for the next stage, and wherein the initial damaged oil is formed by subjecting the pure oil to 4.5 MGy of gamma radiation.

20. The system of claim 15, wherein the solvent has a boiling point of about 50° C. or greater.
